(19) United States
(12) Patent Application Publication
(10) Pub. No.: US 2017/0171137 A1
(43) Pub. Date: Jun. 15, 2017

(54) SMART ANALYSIS FOR SOCIAL MEDIA CONTENT

(71) Applicant: International Business Machines Corporation, Armonk, NY (US)

(72) Inventors: Vikrant Akavaram, Foster City, CA (US); Lisa M. Bradley, Cary, NC (US); Lillian Y. Lei, Moss Beach, CA (US); Lawrence Louie, San Jose, CA (US)

(21) Appl. No.: 14/963,525

(22) Filed: Dec. 9, 2015

(51) Int. Cl. H04L 12/58; G06F 17/30; H04L 29/08

(52) U.S. Cl. CPC H04L 51/32; H04L 67/306; G06F 17/30522

(57) ABSTRACT

A method of analyzing social media content includes loading, into a non-volatile memory, a social profile associated with a user, sensing, through a processor, a posting to a social media topic thread, determining, through the processor, an interest level of the user in the social media topic thread, and providing, through the processor, an alert to the user to engage with the social media topic thread.

### BACKGROUND

The present invention relates to the art of social networking and, more particularly, to a smart analysis system for social media content.

Social media is ubiquitous in modern society. Individuals, corporations, companies, and groups employ social media as one means of communicating with friends, family, customers and members. As social networks grow, the number of alerts a user may receive on a daily basis also grows. Alerts may take the form of postings by friends, customer complaints and/or praise, and group activities. Tracking such alerts may be time consuming and result in a number of interactions with items of little or no interest, or items of past interest. As a result, a social media user may become frustrated with social media interactions.

### SUMMARY

According to an exemplary embodiment of the present invention, a method of analyzing social media content includes loading, into a non-volatile memory, a social profile associated with a user, identifying, through a processing device, a posting to a social media topic thread, determining, through the processing device, an interest level of the user in the social media topic thread, and providing, through the processing device, an alert to the user to engage with the social media topic thread.

According to another aspect of an exemplary embodiment, a computer program product for analyzing social media content comprising a computer readable storage medium having computer readable program code embodied therewith, the computer readable program code, when executed by a processor, causing the processor to: load, into a non-volatile memory, a social profile associated with a user, identify, through the processor, a posting to a social media topic thread, determine, through the processor, an interest level of the user in the social media topic thread, and provide, through the processor, an alert to the user to engage with the social media topic thread.

According to yet another aspect of an exemplary embodiment, a system includes a central processor unit (CPU), a non-volatile memory operatively connected to the CPU, and a social media content analyzing module configured to analyze social media posting and provide an alert to a user to engage with a social media topic thread. The social networking module includes computer readable program code embodied therewith, the computer readable program code, when executed by the CPU, causes the CPU to: load, into the non-volatile memory, a social profile associated with a user, identify, through the processor, a posting to the social media topic thread, determine, through the processor, an interest level of the user in the social media topic thread, and provide, through the processor, an alert to the user to engage with the social media topic thread.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a system for analyzing social media content, in accordance with an exemplary embodiment, and

FIG. 2 depicts a flow chart illustrating a method of analyzing social media content, in accordance with an aspect of an exemplary embodiment.

### DETAILED DESCRIPTION

Embodiments include systems, methods, and computer program products for analyzing social media content. In one embodiment, an interest level of a user in a social media topic thread is determined. Based on the interest level, an alert may be provided to the user to re-engage with the social media topic. The interest level may be determined by statistically analyzing the social media topic thread. For example, other users in the social media topic thread, and their corresponding social media profile, may be analyzed to determine a connection to the user and a likelihood that responses may be posted along with a type of feedback being posted. Further, notification patterns may be evaluated by comparing words, responses, and/or friends of the user engaged with a particular topic thread to statistically determine when to signal the user that it may be time to re-engage. Thus, the exemplary embodiments allow a user to maintain contact and interactions with a social media topic thread of interest without being bombarded by activity notifications that may not be of interest. Reducing nuisance notifications may enhance a user's likelihood of interacting with a social media forum and maintain contact with information of interest.

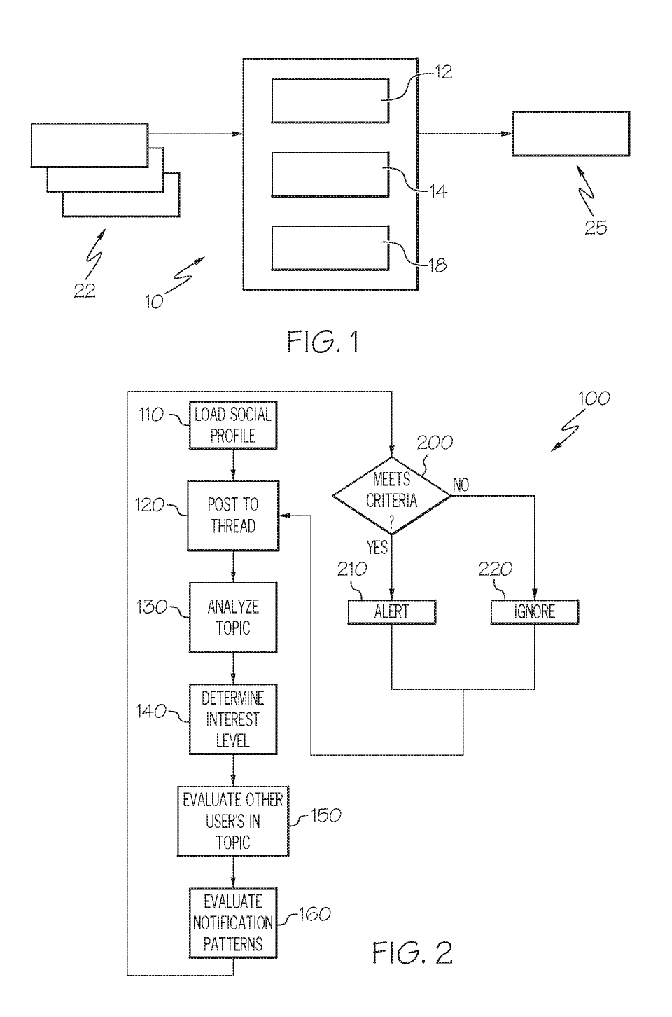

With reference now to FIG. 1, a system for analyzing social media content, in accordance with an exemplary embodiment, is indicated generally at 10. System 10 includes a central processing unit (CPU) operatively connected to a non-volatile memory 14. System 10 also includes a social network module 18 operatively connected to CPU 12 and non-volatile memory 14. As will be detailed more fully below, social networking module 18 monitors a user's social networking postings 22 as well as postings of others to a social media topic thread. Social networking module 18, using, in part, textual and/or statistical analysis provides the user with an alert 25 indicating that engagement, or re-engagement, with the social networking topic thread is indicated.

Reference will now follow to FIG. 2 in describing a method 100 of analyzing social media content, in accordance with an aspect of an exemplary embodiment. In block 110, the user's social media profile is loaded into non-volatile memory 14. The social media profile may include one or more of: the user's likes and/or dislikes, comment history, friends graph (e.g., social graph), and communication patterns with other users and/or groups of users. The comment history may include comments to the user's own postings, posting to friends comment threads, and posting to other's comment threads.

In block 120, social networking module 18 identifies a posting to a social media topic thread. The posting may represent a new thread, a comment to another thread, or the like. In block 130 the social media topic thread is analyzed using textual analysis. In block 140, a determination is made whether the social media topic thread is of interest to the user. Specifically, social networking module 18 may statistically evaluate the user's profile to determine whether the post to the social media topic thread may be of interest. In block 150, social networking module 18 evaluates other user's in the social media topic thread, and their corresponding social media profile, to determine a connection to the user and a likelihood that responses may be posted along with a type of feedback being posted.

In block 160, social networking module 18 may statistically evaluate notification patterns and notification preferences of the user. For example, social networking module 18 may statistically evaluate how often the user engages with the topic thread or similar topic thread, how many responses the user posts, how many posts may be from a single individual, whether the single individual is a social networking friend, how many responses have been posted that would be of interest to the user, how many interactions from a respected friend, and or the tone of the response(s). For example, social networking module 18 may compare words, responses, and/or friends of the user engaged with a particular topic thread to statistically evaluate notification patterns and determine when to signal the user that it may be time to re-engage. Of course, it should be understood that other metrics could be employed to determine user problems and preferences. Preferences could also include user selected preferences and/or default settings for preferences.

In accordance with an aspect of an exemplary embodiment, social networking module 18 employs textual and/or statistical analysis to determine posts of interest, questions of interest, and/or a tone of the comment in the social media topic thread. For example, social networking module 18 may determine that a number of substantial posts have been added to a topic. A user may opt to be notified after a certain number of substantial posts is perceived. Also, social networking module 18 may determine that a number of questions from one or more respected friends which may, or may not be designated Subject Matter Experts (SME). A user may select to be notified after a certain number of such questions are posted. Alternatively, after a textual analysis of a particular question(s), social networking module 18 may determine that an immediate response may be desirable. If so, a user may be sent an immediate notification indicating the presence of such a question.

Thus, if the number of posts of interest, questions of interest and/or tone meets predetermined criteria in block 200, an alert is provided to the user in block 210 that it may be time to engage or reengage with the social media topic. If the number of posts of interest, questions of interest and/or tone does not meet the predetermined criteria, the post may be ignored in block 220. The predetermined criteria may be user defined or established through default values. For example, an alert may be provided after a predetermined number of postings are deemed to have a negative tone. An alert may be posted when a particular friend has made a predetermined number of engagements or interactions with the social medial topic. As another example, if the user has an interest in a certain topic, social networking module 18 may trigger an alert once a predetermined number of friends have engaged in a particular topic thread.

At this point, it should be understood that exemplary embodiments describe a system for monitoring posts to social media topic threads and providing alerts to a user only after one or more criteria have been met. In this manner, the user is not bombarded on a daily basis with notifications regarding social networking engagements. Further, the exemplary embodiments ensure that notifications are sent to the user on topics of interest. In this manner, the user may avoid the need to review and/or clear notifications pertaining to topic threads of past interest, or topic threads of little or no interest. Thus, the exemplary embodiments enhance a user's overall interaction experience with one or more social networking platforms.

In one example, a user has an interest of “big data.” The user writes her thoughts on “big data” on a social networking tool, and does not login the web site for some time. The smart analytic social networking engine analyzes and understands the user's post is about “big data,” and based on the user's friend graph, it further understands that a group of the users' friends, “group A,” who are interested in this topic, and are likely to respond to the post with a lot of interesting feedback and questions, based on their previous post history. The smart analytic social networking engine monitors the responses to the particular post regarding “big data,” and automatically notifies the user when there are three responses to the topic about “big data.” The user can then login to review the posts in a timely manner. Accordingly, a user can use the smart analytic social networking engine to monitor and manage responses to their posts.

In another example, a user is interested in the topic of photography, and the user creates a post about photography in a different time. The smart analytic social networking engine analyzes and determines the post is relating to photography, and finding out the user has another of friends “group B” who are interested in the topic based on their postings and profiles. The smart analytic social networking engine understands that “group A” and “group B” can have overlap. Based on “group B′s” post history, behavior and personal profiles, this time the smart analytic social networking engine decided that it may take up to ten days for a few responses to be posted, because most users in this group usually don't respond to this kind of posts right away. Accordingly, the smart analytic social networking engine does not notify the original user until after ten days and when there are up to three useful responses are provided.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of analyzing social media content comprising:
loading, into a non-volatile memory, a social profile associated with a user;
identifying, using a processing device, a posting to a social media topic thread;
determining, using the processing device, an interest level of the user in the social media topic thread; and
providing, through the processing device, an alert to the user to engage with the social media topic thread.

2. The method of claim 1, further comprising: evaluating other users in the social media topic thread for a connection to the user.

3. The method of claim 2, further comprising: statistically analyzing other users having a connection to the user to determine a likelihood of a response.

4. The method of claim 1, further comprising: evaluating notification patterns established by the user.

5. The method of claim 4, wherein evaluating notification patterns includes determining one of a number of posts to a similar social media topic thread, a number of posts to the social media topic thread for a selected period, determining a number of posts to the social media topic thread by friends of the user for a selected period.

6. The method of claim 1, further comprising: evaluating notification preferences established by the user.

7. The method of claim 1, wherein determining, through the processing device, an interest level of the user includes statistically analyzing past responses of the user.

8. The method of claim 1, wherein, identifying, through the processing device, a posting to a social media thread includes determining a tone of one or more responses to the social media topic thread.

9. The method of claim 8, wherein determining the tone of the one or more responses includes identifying a negative tone in the one or more responses, and providing, through the processing device, the alert to the user after sending a predetermined number of the one or more responses having the negative tone.

10. A computer program product for analyzing social media content comprising a computer readable storage medium having computer readable program code embodied therewith, the computer readable program code, when executed by a processor, causing the processor to:
load, into a non-volatile memory, a social profile associated with a user;
identify, through the processor, a posting to a social media topic thread;
determine, through the processor, an interest level of the user in the social media topic thread; and
provide, through the processor, an alert to the user to engage with the social media topic thread.

11. The computer program produce according to claim 10, wherein the computer readable program code, when executed by the processor, causes the processor to: evaluate other users in the social media topic thread for a connection to the user.

12. The computer program produce according to claim 11, wherein the computer readable program code, when executed by the processor, causes the processor to: statistically analyze other users having a connection to the user to determine a likelihood of a response.

13. The computer program produce according to claim 10, wherein the computer readable program code, when executed by the processor, causes the processor to: evaluate notification patterns established by the user.

14. The computer program produce according to claim 13, wherein the computer readable program code, when executed by the processor, causes the processor to: determine one of a number of posts to a similar social media topic thread, a number of posts to the social media topic thread for a selected period, determining a number of posts to the social media topic thread by friends of the user for a selected period, when evaluating notification patterns established by the user.

15. The computer program produce according to claim 10, wherein the computer readable program code, when executed by the processor, causes the processor to: evaluate notification preferences established by the user.

16. The computer program produce according to claim 10, wherein the computer readable program code, when executed by the processor, causes the processor to: statistically analyze past responses of the user when determining, through the processor, an interest level of the user.

17. The computer program produce according to claim 10, wherein the computer readable program code, when executed by the processor, causes the processor to: determine a tone of one or more responses to the social media topic thread when sensing, through the processor, the posting to a social media topic thread.

18. The computer program produce according to claim 17, wherein the computer readable program code, when executed by the processor, causes the processor to: identify a negative tone in the one or more responses, and providing, through the processor, the alert to the user after sensing a predetermined number of the one or more responses having the negative tone when determining the tone of the one or more responses.

19. A system comprising:
a central processor unit (CPU);
a non-volatile memory operatively connected to the CPU; and
a social media content analyzing module configured to analyze social media posting and provide an alert to a user to engage with a social media topic thread, the social networking module including computer readable program code embodied therewith, the computer readable program code, when executed by the CPU, causes the CPU to:
load, into the non-volatile memory, a social profile associated with a user;
identify, through the processor, a posting to the social media topic thread;
determine, through the processor, an interest level of the user in the social media topic thread; and
provide, through the processor, an alert to the user to engage with the social media topic thread.

20. The system according to claim 19, wherein the computer readable program code, when executed by the processor, causes the processor to:
evaluate other users in the social media topic thread for a connection to the user; and
statistically analyze other users having a connection to the user to determine a likelihood of a response.
